(19) United States
(12) Patent Application Publication
(10) Pub. No.: US 2014/0109896 A1
(43) Pub. Date: Apr. 24, 2014

(54) FIREPITS AND GRILLS FORMED FROM THE SAME

(71) Applicant: Clay Gower Codner, Cincinnati, OH (US)

(72) Inventor: Clay Gower Codner, Cincinnati, OH (US)

(21) Appl. No.: 13/658,196

(22) Filed: Oct. 23, 2012

(51) Int. Cl. A47J 37/07

(52) U.S. Cl. 126/9 B

(57) ABSTRACT

A firepit is disclosed including a frame and a hammock. The frame includes at least one support structure. The hammock is supported by the at least one support structure. The hammock is configured to be rollable and capable of withstanding a temperature of about 700° F. or more. Grills are also disclosed including a frame, a hammock, and a grate.

### TECHNICAL FIELD

The present disclosure generally relates to firepits and grills.

### BACKGROUND

Various firepits and grills are known. Firepits can include those devices that provide an individual with a fire for light, warmth, and/or entertainment, and grills can include those devices that allow an individual to cook food over a heat source. Traditionally, firepits have been stationary and generally in contact with the ground. However, firepits and grills can often include large, rigid, bulky, and/or heavy designs that can be difficult to store and transport. Thus, what is desired is a firepit or grill that can be portable and/or collapsible.

### SUMMARY

In accordance with one embodiment, a firepit comprises a frame and a first hammock. The frame includes an adapter, a plurality of legs, and a plurality of cross members. Each of the plurality of legs has a top end and a bottom end and each leg is pivotally coupled to the adapter, proximate the top end. Each leg is configured to pivot between an extended position and a collapsed position. Each of the plurality of cross members has a first arm pivotally coupled to a second arm. The first arm is pivotally coupled to one of the plurality of legs. The second arm is pivotally coupled to a neighboring leg. The first and second arms are configured to pivot with respect to each other as the plurality of legs pivot between the extended position and the collapsed position. The first hammock is releasably coupled to the frame. The first hammock is substantially positioned beneath the adapter and within a space defined by the plurality of legs. The first hammock is configured to be rollable. The first hammock is capable of withstanding a temperature of about 700° F. or more.

In accordance with another embodiment, a grill comprises a frame, a first hammock, and a grate. The frame includes an adapter, a plurality of legs, and a plurality of cross members. Each of the plurality of legs has a top end and a bottom end and each leg is pivotally coupled to the adapter, proximate the top end. Each of the legs is configured to pivot between an extended position and a collapsed position. Each of the plurality of legs includes an outer portion and an inner portion. The outer portion is configured to receive the inner portion, such that the inner portion is slidably extendable from and retractable into the outer portion. Each of the plurality of legs is coupled to each of its respective neighboring legs by one of a plurality of cross members. Each of the plurality of cross members has a first arm pivotally coupled to a second arm. The first arm is pivotally coupled to one of the plurality of legs. The second arm is pivotally coupled to a neighboring leg. The first and second arms are configured to pivot with respect to each other as the plurality of legs pivot between the extended position and the collapsed position. The first hammock is releasably coupled to the frame. The first hammock is substantially positioned beneath the adapter and within a space defined by the plurality of legs. The first hammock is configured to be rollable. The first hammock is capable of withstanding a temperature of about 1,000° F. or more. The grate is releasably coupled to the frame. The grate is substantially positioned over the first hammock. The grate includes a plurality of bars. Each of the bars is arranged substantially parallel to each other and connected at each end to a flexible strip. The grate is configured to be rollable.

In accordance with yet another embodiment, a firepit comprises a frame and a hammock. The frame includes a first support structure and a second support structure. The hammock is configured to releasably attach to the frame between the first support structure and the second support structure. The hammock is configured to be rollable. The hammock is capable of withstanding a temperature of about 1,000° F. or more.

In accordance with yet another embodiment, a firepit comprises a frame and a hammock. The frame comprises at least one support structure. The hammock is substantially supported by the at least one support structure. The hammock is configured to be rollable. The hammock is capable of withstanding a temperature of about 1,000° F. or more.

In accordance with yet another embodiment, a hammock is configured to hold a fuel load. The hammock is rollable and capable of withstanding a temperature of about 1,000° F. or more.

### BRIEF DESCRIPTION OF THE DRAWINGS

It is believed that certain embodiments will be better understood from the following description taken in conjunction with the accompanying drawings in which:

FIG. 1 is a perspective view of a firepit according to one embodiment, shown with a frame in an extended position, the frame including an adapter, legs, and cross members and substantially supporting a hammock.

FIG. 2 is a perspective view of a firepit of FIG. 1, wherein the firepit has been converted into a grill and is shown with a frame in an extended position, the frame including an adapter, legs, and cross members and substantially supporting a hammock and a grate.

FIG. 3 is a perspective view of the firepit of FIG. 1, shown with the frame in a collapsed position and the hammock removed and in a rolled orientation.

FIG. 4 is perspective view of one example of an adapter generally shown in FIG. 1.

FIG. 5 is a perspective view of a cross member according to one embodiment, the cross member including a first arm and a second arm and shown in association with a hinge attachment having a tab.

FIG. 6 is a perspective view of a frame of a firepit according to another embodiment, the frame is shown in an extended position.

FIG. 7 is a perspective view of a grill according to one embodiment, shown with a frame in an extended position, the frame including an adapter, legs, and cross members and substantially supporting a first hammock, a second hammock and a grate.

FIG. 8 is a top view of the grate of FIG. 2, shown with a plurality of bars and a flexible strip.

FIG. 9 is a perspective view of a firepit according to another embodiment, shown with a hammock suspended from a support structure.

FIG. 10 is a perspective view of a firepit according to yet another embodiment, shown with a support structure substantially supporting a hammock.

FIG. 11 is a perspective view of a firepit according to yet another embodiment, shown with a hammock releasably attached to a first support structure and a second support structure.

### DETAILED DESCRIPTION

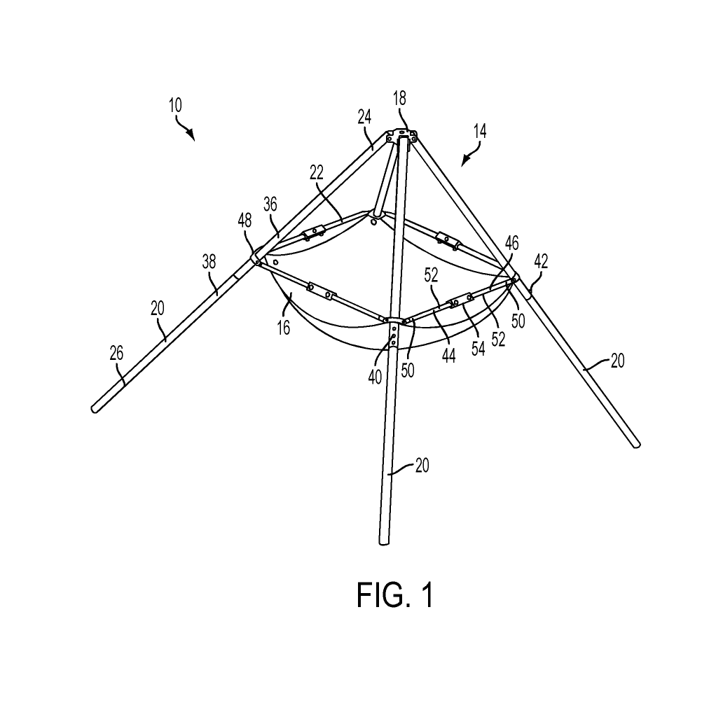

Traditional firepits can have limited functionality and flexibility. Firepits described herein can have increased versatility and offer a number of advantages over the traditional firepits. FIG. 1 depicts one such firepit. As illustrated in FIG. 1, a firepit 10 can include a frame 14 and a first hammock 16, both of which can be collapsible.

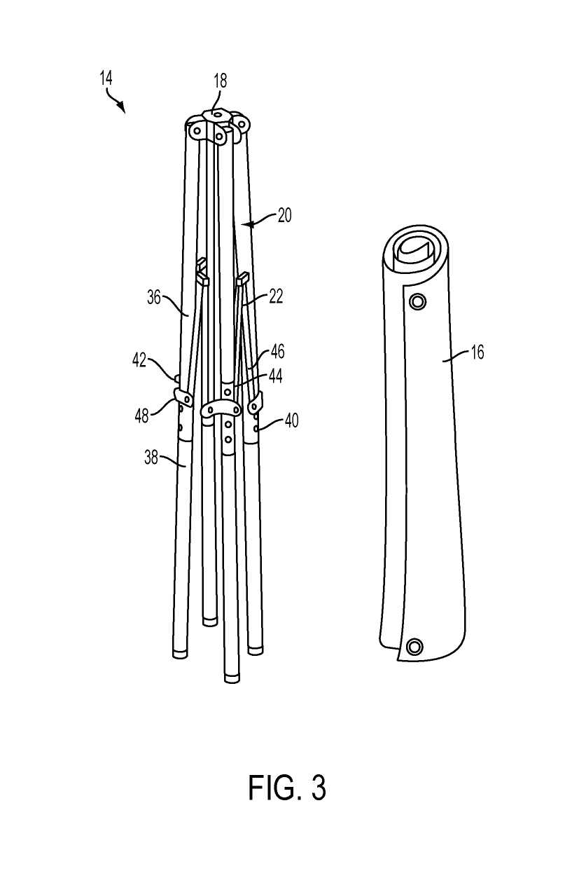

As illustrated in FIG. 1, the frame 14 can include an adapter 18, a plurality of legs 20, and a plurality of cross members 22. Each of the plurality of legs 20 can be pivotally coupled to the adapter 18 such that the plurality of legs 20 can pivot between an extended position, as shown in FIG. 1, and a collapsed position, as shown in FIG. 3. Furthermore, the first hammock 16 can be releasably coupled to the frame 14. For example, in certain embodiments, the first hammock 16 can be substantially positioned (during use) beneath the adapter 18 and within a space defined by the plurality of legs 20 when the frame 14 is in the extended position. As illustrated in FIG. 3, the first hammock 16 can be separated from the frame 14 when the frame 14 is in the collapsed position, and in such embodiments, the first hammock 16 can be configured to be rollable. A hammock can be rollable, such that it can be formed or gathered into a tube, cylinder, and/or bundle. A rollable hammock can provide numerous advantages. For example, a rollable hammock can be packaged more easily, making it more portable before and after use.

In certain embodiments, a hammock can be capable of withstanding a temperature of about 700° F. or more, in certain embodiments a temperature of about 900° F. or more, in certain embodiments a temperature of about 1,000° F. or more, in certain embodiments a temperature of about 1,200° F. or more; and in certain embodiments a temperature of about 1,500° F. or more. A hammock can be formed from a variety of suitable materials, including for example, stainless steel. Other suitable materials are further described herein. Though the first hammock 16 is shown in FIG. 3 to be separate from the frame 14 and rolled into a bundle, it will be appreciated that in certain embodiments, a hammock can remain coupled to a frame in a collapsed position such that the hammock can be configured to be deformable.

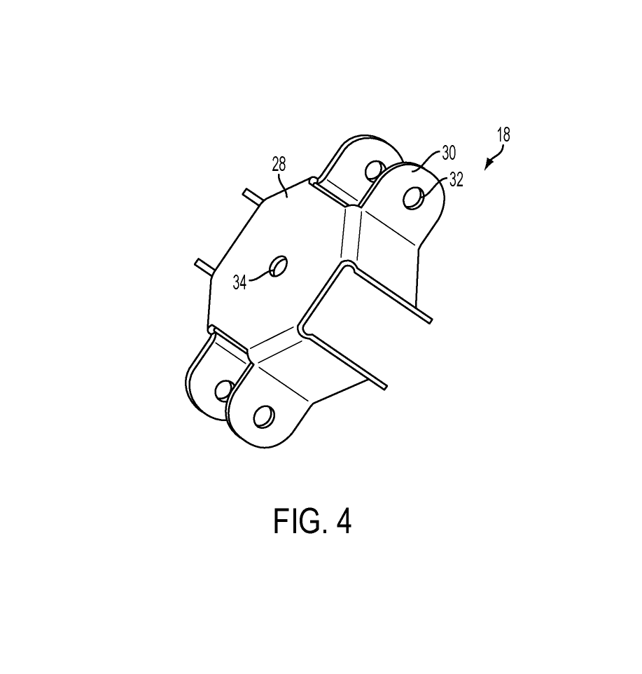

As illustrated in FIGS. 1-3, each of the plurality of legs 20 can have a top end 24 and a bottom end 26 and can be pivotally coupled to the adapter 18. In one embodiment, and as most clearly shown in FIG. 4, the adapter 18 can be configured to receive one or more of a plurality of legs. An adapter can be machined or manufactured from a plate, a ring or any other of a variety of shaped articles. As illustrated in FIG. 4, edges of a plate 28 can be bent to form one or more pairs of hinge tabs 30. Each pair of hinge tabs 30 can include corresponding apertures 32 such that each hinge tab 30 can be configured to receive a pin, a screw, and the like therethrough. In such an embodiment, each of the plurality of legs 20 can include one or more openings that correspond to the apertures 32 such that each of the plurality of legs 20 can be pivotally coupled to the adapter 18. In certain embodiments, and as illustrated in FIGS. 1-3, the adapter 18 can be pivotally coupled to each of the plurality of legs 20 proximate the top end 24. However, it will be appreciated that in other embodiments, an adapter can be pivotally coupled to a leg at a location other than at a top end of the leg. Furthermore, while FIG. 4 shows an embodiment including pairs of hinge tabs, it will be appreciated that in other embodiments, a hinge tab can be configured to receive one or more of a plurality of legs without the assistance of another hinge tab or in association with two or more hinge tabs.

The adapter 18 can further include an eyelet 34, wherein the adapter 18 can be configured to receive an eyebolt (not shown). In one embodiment, as shown in FIG. 4, the eyelet 34 can be substantially centrally positioned on the plate 28 such that an eyebolt can be positioned so as not to prevent the frame 14 from moving to a collapsed position. Similarly, in certain embodiments, the plate 28 can be sized so as to prevent an eyebolt from preventing the frame 14 from moving to a collapsed position. An eyebolt can be secured from the adapter 18, for example, with one or more nuts and can suspend pots, pans, food, and other items over the first hammock 16.

In certain embodiments, each of the plurality of legs 20 can be retractable and/or extendable. As shown in FIGS. 1-3, each of the plurality of legs 20 can include an outer portion 36 and an inner portion 38. The outer portion 36 can be configured to receive the inner portion 38 such that the inner portion 38 can be slidably extendable from and retractable into the outer portion 36. The outer portion 36 can be substantially hollow and can include two or more vertically-spaced gaps 40, while the inner portion 38 can include a snap button 42, which can protrude from the inner portion 38 through one of the two or more vertically-spaced gaps 40 on the outer portion 36. A length of each of the plurality of legs 20, as defined by the respective outer and inner portions 36, 38, can be adjustable. The snap button 42 can be biased outwardly from the inner portion 38, such that movement between the outer and inner portions 36, 38 can be substantially prevented while the snap button 42 protrudes through one of the two or more vertically-spaced gaps 40, and wherein depressing the snap button 42 can release the inner portion 38 to move within the outer portion 36. While FIGS. 1-3 depict the outer portion 36 to be pivotally coupled to the adapter 18, it will be appreciated that in other embodiments, an inner portion can be pivotally coupled to an adapter. In other embodiments, the outer and inner portions 36, 38 can be coupled with a twist-lock clamping mechanism. Such suitable connections can provide movement and adjustability between the outer and inner portions 36, 38. By having adjustability, the legs can have different lengths preventing the hammock from touching the ground if so desired. During use, any fire or flames could cause potential damage to the area below the hammock, so having substantial distance between the bottom of a hammock and the ground, or any surface, is advantageous.

In certain embodiments, a leg can have a footer connected to the bottom end of the leg. Such footers could contact the ground surface providing increased stability to the firepit (or grill) during use. Such footers can be formed from the same material as the legs or a frame.

As illustrated in FIGS. 1-3, and as described herein, the frame 14 can include a plurality of cross members 22. In certain embodiments, the plurality of cross members 22 can provide support to the plurality of legs 20 and/or secure the plurality of the legs 20 when the frame 14 is in the extended position. Each of the plurality of cross members 22 can include a first arm 44 and a second arm 46, wherein the first and second arms 44, 46 can be pivotally coupled to each other. The first arm 44 can be pivotally coupled to one of a pair of neighboring legs, as shown in FIGS. 1-3, and the second arm 46 can be pivotally coupled to the other leg. When referring to a particular leg, a neighboring leg can refer to a leg that is next to the particular leg. As such, a pair of neighboring legs can refer to two legs that are next to each other. The first and second arms 44, 46 can be configured to pivot with respect to each other as the plurality of legs 20 pivot when the frame 14 moves between the extended position and the collapsed position.

In certain embodiments, and as shown in FIGS. 1-3, one or more of the plurality of legs 20 can include a strap 48, such that the first arm 44 and/or second arm 46 can be pivotally coupled thereto. In such embodiments, the strap 48 can conform to and be permanently attached to the leg 20 by any of soldering, brazing, welding, epoxy, or any other suitable fastening technique. In certain embodiments, an angle formed by each strap 48 can be a factor in influencing a shape of the frame 14 as the angles can determine an arrangement of the plurality of the cross members 22 and, as a result, the plurality of legs 20.

As illustrated in FIGS. 1-3, each of the plurality of legs 20 can be coupled to each of its respective neighboring legs by one of a plurality of cross members 22. For example, and as shown in FIGS. 1-3, the frame 14 can include four legs 20 and four cross members 22, wherein each leg 20 can be coupled to a neighboring leg by one cross member 22. However, it will be appreciated that in other embodiments, a frame can include fewer legs. In other embodiments, one or more of a plurality of legs may only be coupled to one neighboring leg by a cross member, instead of two neighboring legs, and one or more of a plurality of legs may not include any such coupling by a cross member. Furthermore, it will be appreciated that in other embodiments, two or more cross members can be used to couple a pair of neighboring legs.

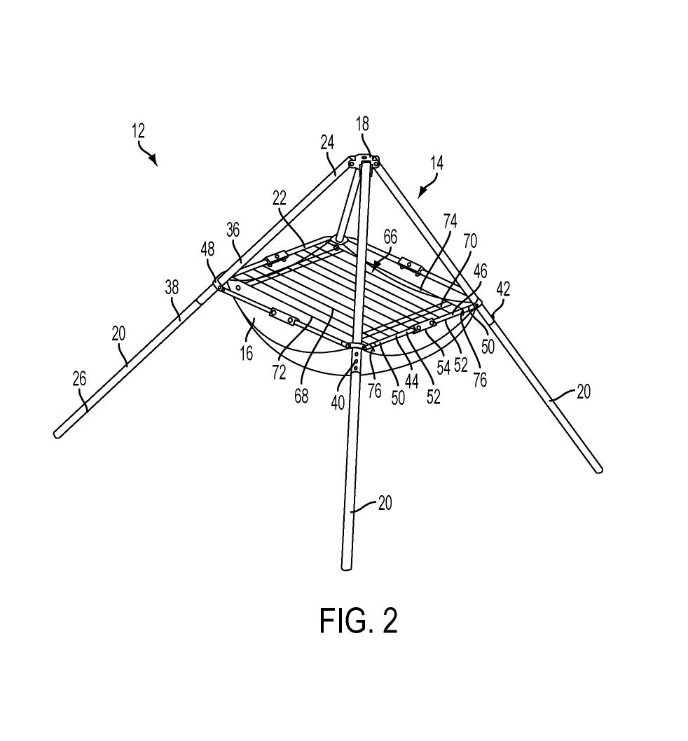

Each of the first and second arms 44, 46 can include a first end 50 and a second end 52. In certain embodiments, first and second arms 44, 46 can be pivotally coupled to each other at the respective second ends 52. Furthermore, each of the first and second arms 44, 46 can be pivotally coupled to each other by a cross member hinge 54. In one embodiment, and as shown, for example, in FIGS. 1-2, the cross member hinge 54 can be a ladder hinge. In such an embodiment, the ladder hinge can be coupled to each of the first and second arms 44, 46 at the respective second ends 52 such that there are two pivot points. The ladder hinge can include an elongated body that covers a portion of each of the first and second arms 44, 46 proximate the respective pivot points, such that the ladder hinge can prevent further pivoting with respect to the first and second arms 44, 46 beyond the extended position.

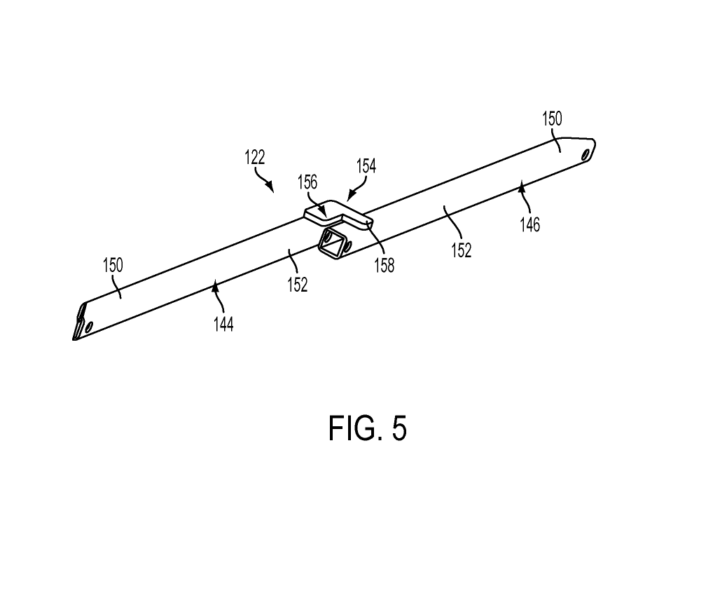

In another embodiment, as shown in FIG. 5, a first arm 144 and a second arm 146 can be pivotally coupled to each other at respective second ends 152 by a cross member hinge 154. The cross member hinge 154 can include a hinge attachment 156 having a hinge attachment tab 158. A pin, a screw, or other suitable connector can be used to form such a hinge. The hinge attachment 156 can be positioned proximate the second end 152 of one of the first and second arms 144, 146, such that the hinge attachment tab 158 can extend over the second end 152 of the other arm and prevent further pivoting between the first and second arms 144, 146 beyond the extended position. In certain embodiments, and as shown in FIG. 5, the hinge attachment 156 can be permanently attached to the cross member 122 by any of soldering, brazing, welding, and epoxy, and in other embodiments, a hinge attachment can be releasably coupled to a cross member. As in the embodiment shown in FIG. 5, the first and second arms 144, 146 can include a plurality of openings. Openings at respective first ends 150 of the first and second arms 144, 146 can be provided in a plane that is perpendicular from a plane in which openings are provided at the respective second ends 152 of the first and second arms 144, 146. While the cross member 122 in FIG. 5 is shown to include the first and second arms 144, 146 having a square cross section, it will be appreciated that in other embodiments, first and second arms can include any of a variety of other cross-sectional shapes.

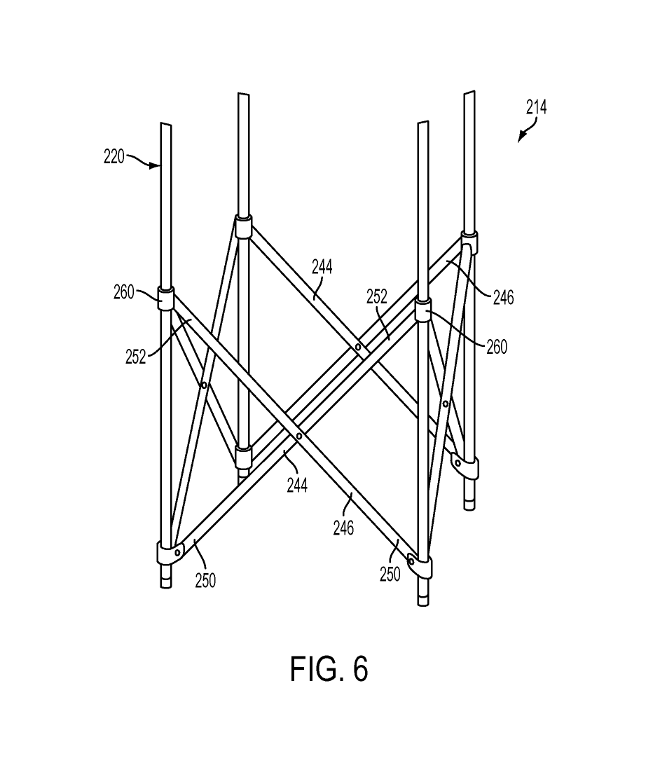

As illustrated in FIG. 6, first and second arms 244, 246 can define an intersection at which the first and second arms 244, 246 can be pivotally coupled to each other. In such an embodiment, the first arm 244 can be pivotally coupled to one of a pair of neighboring legs at its first end 250 and slidably coupled to the other leg at its second end 252, and the second arm 246 can be pivotally coupled to the other leg at its first end 250 and slidably coupled to the one of the pair of neighboring legs at its second end 252. The first and second arms 244, 246 can be configured to pivot with respect to each other as the plurality of legs 220 pivot when the frame 214 moves between the extended position and the collapsed position. Furthermore, each the first and second arms 244, 246 can slide along the pair of neighboring legs at the respective second ends 252. In one embodiment, the second ends 252 of each of the first and second arms 244, 246 can be slidably coupled to the plurality of the legs 220 with a compound hinge 260.

In certain embodiments, parts of the frame 14 can be formed from mild steel. Other suitable materials from which the parts of the frame 14 can be formed can include, but are not limited to medium carbon steel, high carbon steel, aluminum, copper, brass, stainless steel, bronze, and combinations thereof. However, it will be appreciated that parts of a frame can be formed from any of a variety of other suitable materials such that a material can withstand heat emitted from a fuel load (e.g., temperatures above 1,000° F.) to a particular location of the frame where the material is intended for use. In certain embodiments, parts of the frame 14 can include a coating such as for example, a high-temperature paint, powder coat, metal-plated coating, or any of a variety of other suitable coatings that can prevent corrosion.

As described herein, and as illustrated in FIGS. 1-2, a first hammock 16 can be releasably coupled to a frame 14, such that the first hammock 16 can be substantially positioned beneath an adapter 18 and within a space defined by a plurality of legs 20. In certain embodiments, the first hammock 16 can be releasably coupled to the frame 14 at one or more of the plurality of legs 20, as illustrated in FIGS. 1-2. In other embodiments, the first hammock 16 can be releasably coupled to the frame 14 at one or more of the plurality of cross members 22. The first hammock 16 can be releasably coupled to the frame 14 at both one or more of the plurality of legs 20 and one or more of the plurality of cross members 22. In one embodiment, the first hammock 16 can include one or more grommets and hooks (e.g., S-hooks) with which the first hammock can be releasably coupled to the frame 14. In one embodiment, the cross member hinges 54 and/or one or more of the plurality of legs 20 can include a slot in which a hook can be inserted. It will be appreciated that a first hammock can be releasably coupled to a frame by use any of a variety of suitable connectors.

In one embodiment, a hammock can be formed from a stainless steel woven mesh. One advantage of a hammock having a mesh configuration is that during and after use, water, ash, or other remnants can fall through the holes in the mesh surface and onto the ground. Such a configuration reduces the amount of time required to empty or clean the hammock. Other suitable materials for a hammock can include, but are not limited to, knitted stainless steel, mild steel mesh, copper mesh, aluminum mesh, brass mesh, fiberglass cloth, silica cloth, aramid cloth, carbon fiber cloth, Kevlar® cloth, and combinations thereof. However, it will be appreciated that a hammock can be formed from any of a variety of materials such that the hammock can be strong enough to hold a fuel load, such as, for example, charcoal or wood, and can be configured to be rollable and substantially prevent hot ash and sparks from falling therethrough. As set forth above, in certain embodiments, a hammock can be capable of withstanding a temperature of about 1,500° F. or more. In certain embodiments, a hammock can include a coating such as, for example, vermiculite, aluminum, acrylic, nickel plating, chrome plating, or any of a variety of other coatings that can improve corrosion resistance, abrasion resistance, and/or puncture resistance. While the first hammock 16 is shown in FIGS. 1-3 to be substantially flat and have a substantially square shape, it will be appreciated that a hammock can assume any of a variety of shapes and configurations. For example, suitable shapes for a hammock can include a square, a rectangle, a triangle, a circle, an octagon, a cross, a hexagon, and a pentagon. In certain embodiments, a hammock can form a pouch. In other embodiments, a hammock can be formed from a series of parallel plates, plates arranged in a flexible grid, plates arranged in a flexible scale configuration, or a combination thereof.

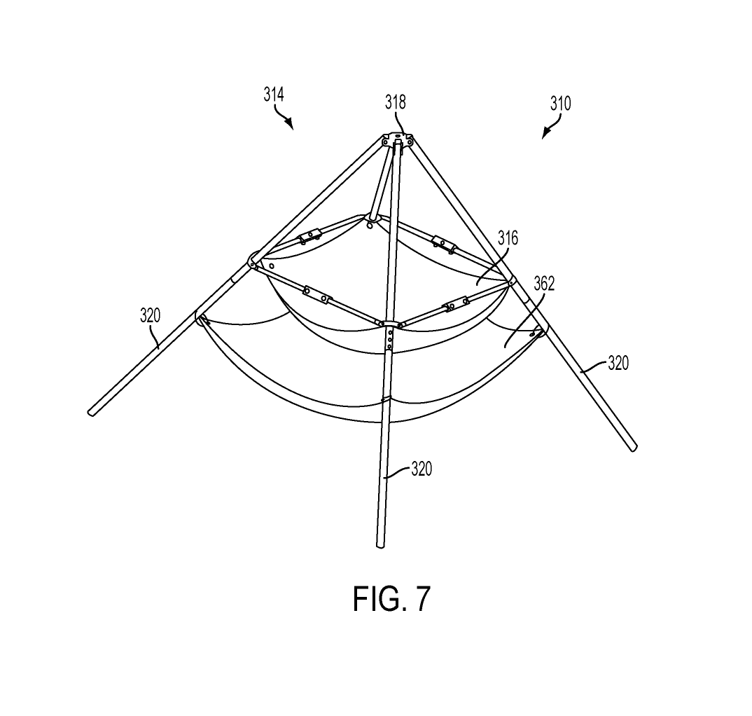

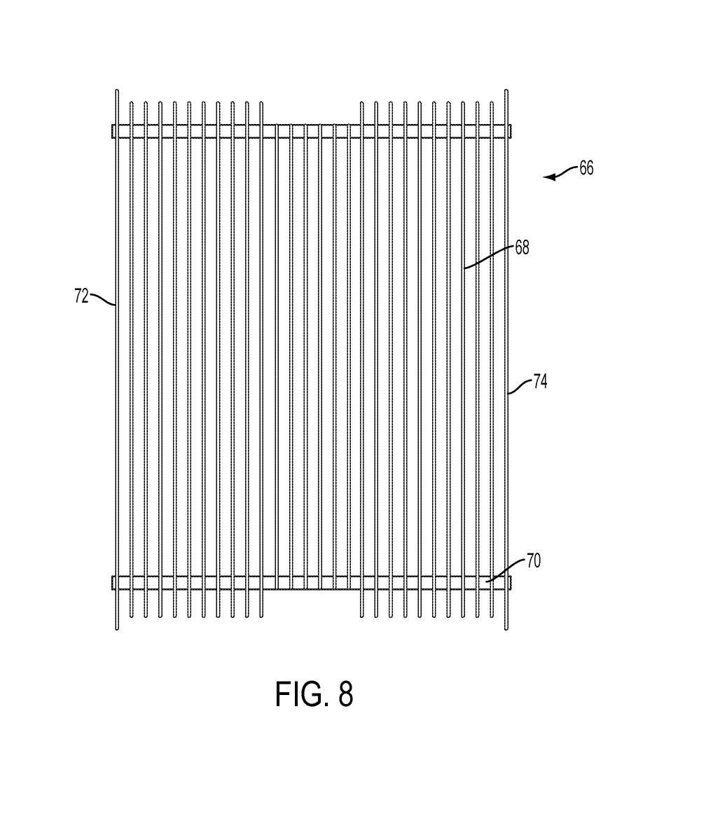

FIG. 7 depicts another embodiment of a firepit 310 having a first hammock 316 and a second hammock 362. In such an embodiment, the second hammock 362 can be releasably coupled to a frame 314, such that the second hammock 362 can be substantially positioned beneath an adapter 318 and within a space defined by a plurality of legs 320. The first hammock 316 can be releasably coupled to the frame 314, such that the first hammock 316 can be substantially positioned beneath the top hinge 318, between the plurality of legs 320, and above the second hammock 362, as illustrated in FIG. 8. In one embodiment, the first and second hammocks 316, 362 can be formed from different materials. For example, the first hammock 316 can be formed of a steel mesh, which can provide strength, heat resistance, and/or puncture resistance for holding a fuel load, and the second hammock 362 can be formed from a fiberglass cloth, which can be configured to receive small embers from the burning fuel load. It will be appreciated, however, that first and second hammocks can be formed from the same materials. Further, it will be appreciated that while the first and second hammocks 316, 362 are shown in FIG. 7 to assume a similar shape and configuration, first and second hammocks can assume different shapes and configurations.

As described herein, the firepit 10 can be further converted into a grill 12, as shown in FIG. 2, by adding a grate 66. The grate 66 can be releasably coupled to the frame 14, such that the grate 66 can be substantially positioned over the first hammock 16. In certain embodiments, and as shown most clearly in FIG. 8, the grate 66 can include a plurality of bars 68, wherein each of the bars 68 can be arranged substantially parallel to each other and connected at each end by a flexible strip 70. In such embodiments, the grate 66 can be configured to be rollable and/or gathered into a bundle such that the grill 12 can be portable and collapsible.

As illustrated in FIG. 8, each of the plurality of bars 68 can have different lengths. For example, bars positioned near outer sides of the grate 66 can have a greater length than bars centrally positioned with the grate 66. In particular, and as shown in FIG. 8, each of a first bar 72 and a last bar 74 can have a length that extends past other bars. As illustrated in FIG. 2, each of the first and last bars 72, 74 can include a bent portion 76 at each end, such that the bent portions 76 of the respective first and last bars 72, 74 can extend over two or more of the plurality of cross members 22 to substantially secure the grate 66 to the frame 14. In such embodiments, one or more additional bars can have at least a long enough length to rest on the cross members 22. It will be appreciated that any of a plurality of bars can include a desired length and end portions to substantially secure a grate to a frame. For example, one or more of a plurality of bars can include at each end a bent portion, a clamp, a hook, or any of a variety of other suitable securing devices. In certain embodiments, each of the plurality of bars 68 can be attached to the flexible strip 70 by, for example, brazing, welding, or any of a variety of other suitable attachment methods. It will be appreciated that the arrangement of the bars to form a grate can have a variety of configurations suitable to form a grate configured for a cooking surface.

In certain embodiments, parts of a grate can be formed from mild steel. Other suitable materials from which the parts of a grate can be formed can include, but are not limited to stainless steel, spring steel, copper, brass, bronze, and combinations thereof. However, it will be appreciated that parts of a grate can be formed from any of a variety of other suitable materials such that a material can withstand heat emitted from a fuel load. In certain embodiments, the parts of a grate can include any of a variety of suitable coatings that can prevent corrosion. For example, a grate can be chrome-plated. In certain embodiments, a base material or coating material therefor can be a material that does not produce toxic chemicals.

In certain embodiments, the firepit 10 and/or the grill 12 can include a spark screen (not shown), wherein the spark screen can be configured to surround at least a portion of the frame 14. In certain embodiments, the spark screen can be configured to be draped and/or wrapped around the frame 14 entirely. In one such embodiment, the spark screen can have a height such that the spark screen can extend from the plurality of cross members 22 to the adapter 18. In another embodiment, the spark screen can rest on the ground while substantially surrounding a portion of the firepit or grill. In certain embodiments, the spark screen can further include a handle, providing ease of use when applying or removing the spark screen from the firepit or grill.

In one embodiment, the spark screen can be formed from a stainless steel mesh. Other suitable materials from which the spark screen can be formed can include, but are not limited to mild steel, copper, bronze, nickel-plated steel, zinc-plated steel, copper-plated steel, chrome-plated steel, and combinations thereof. However, it will be appreciated that a spark screen can be formed from any of a variety of other suitable materials such that a material can withstand heat emitted from a fuel load and can be configured to be rollable. In certain embodiments, the spark screen can be substantially transparent such that the firepit 10 or grill 12 can be visually appealing.

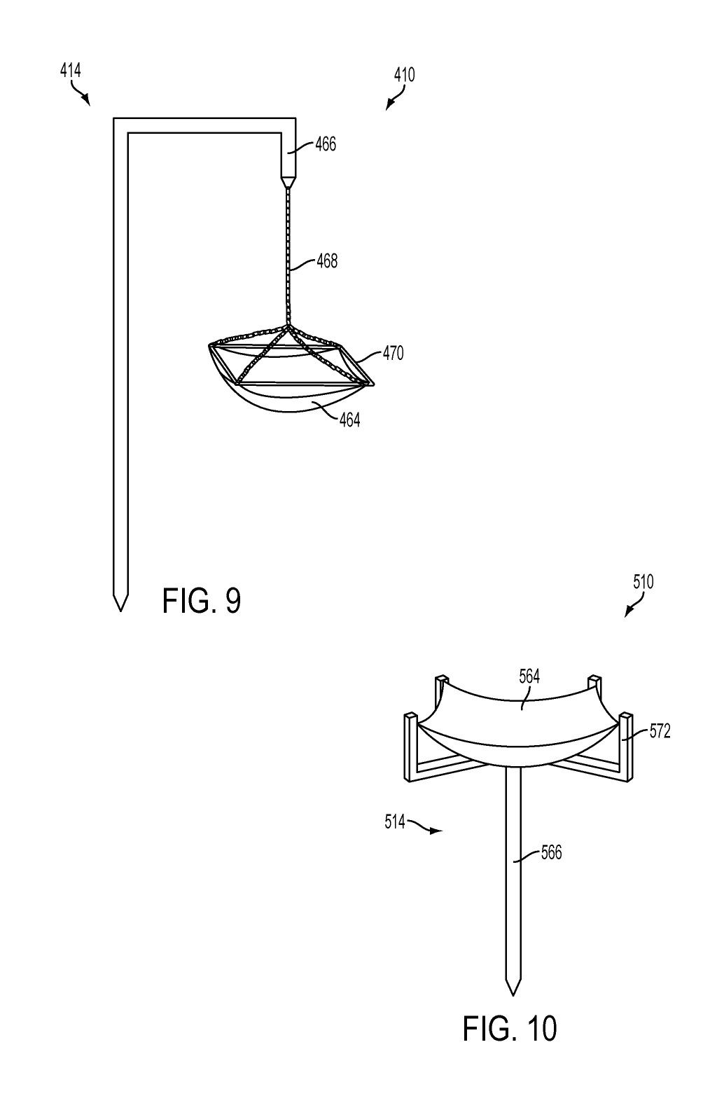

In other examples as illustrated in FIGS. 9 and 10, a firepit 410, 510 can include a frame 414, 514 and a hammock 464, 564, where the frame 414, 514 can include at least one support structure 466, 566 and the hammock 464, 564 can be substantially supported by the at least one support structure 466, 566. As illustrated in FIG. 9, the frame 414 can include one support structure 466 from which the hammock 464 can be suspended. The hammock 464 can be releasably attached to the frame 414 by a chain 468. However, it will be appreciated that in such embodiments, a hammock can be releasably attached to a frame by a rope, cord, wire, or any of a variety of other suitable connectors. While the hammock 464 is shown to have a shape of a square framework 470, it will be appreciated that a hammock can be stretched by a ring or other framework into any of a variety of shapes or configurations. Further, though the support structure 466 is shown to be angled such that the hammock 464 can be suspended therefrom without substantial interference, it will be appreciated that a support structure can be curved, include one or more hinged portions, or can assume any of a variety of other configurations. For example, while the support structure 466 in FIG. 9 is shown to be an angled beam, it will be appreciated that in other embodiments, a support structure can be a post, pole, building wall, tree, a combination thereof, or any of a variety of other suitable structures configured to substantially support a hammock with a burning fuel load.

As illustrated in FIG. 10, the frame 514 can include one support structure 566 substantially supporting the hammock 564, where the support structure 566 is substantially positioned beneath the hammock 564. The hammock 564 can be releasably attached to the frame 514 at ends of each of four prongs 572, which substantially stretch the hammock 564 and give shape thereto. However, it will be appreciated that in such embodiments, a hammock can be releasably attached to a frame and/or stretched by any of a variety of other configurations. In examples such as those depicted in FIGS. 9-10, the support structure 466, 566 can further include a pointed end such that the support structure 466, 566 can be readily inserted into the ground for support.

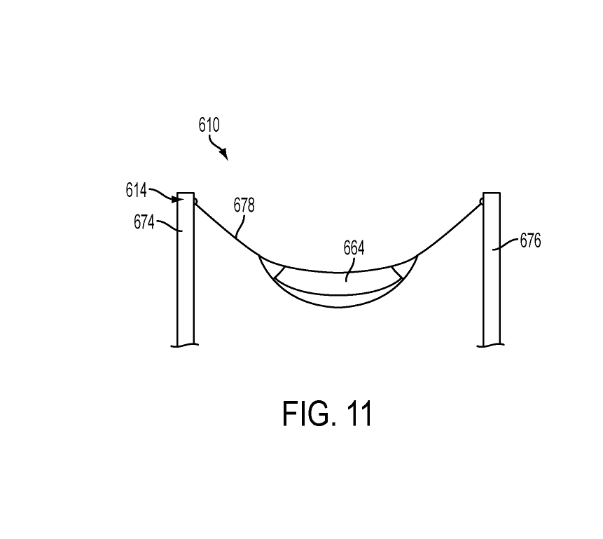

In another embodiment as illustrated in FIG. 11, a firepit 610 can include a frame 614 and a hammock 664, where the frame 614 can include a first support structure 674 and a second support structure 676. The hammock 664 can be configured to releasably attach to the frame 614 and be suspended between the first support structure 674 and the second support structure 676. In one such embodiment, and as illustrated in FIG. 11, the hammock 664 can be releasably attached to each of the first support structure 674 and the second support structure 676 by a rope 678. However, it will be appreciated that in such embodiments, a hammock can be releasably attached to a frame by a chain, cord, wire, or any of a variety of other suitable connectors. Though the hammock 664 is shown in FIG. 11 to be stretched by the rope 678, it will be appreciated that a firepit can further include other frameworks to stretch and/or open a hammock into any variety of shapes or configurations. In one embodiment, and as shown in FIG. 11, first and second support structures 674, 676 can be posts. However, it will be appreciated that each of first and second support structures can be a pole, beam, building wall, tree, a combination thereof, or any of a variety of other suitable structures configured to substantially support a hammock with a burning fuel load. Thus, in certain embodiments, the first and second support structures 674, 676 can be the same or different from one another. Like the support structures 466, 566 in the embodiments depicted in FIGS. 9-10, each of the first and second support structures 674, 676 of FIG. 11 can further include a pointed end such that the first and second support structures 674, 676 can be readily inserted into the ground for support.

It will be appreciated that a hammock being rollable and configured to withstand and support a fuel load can be supported or hung using a variety of arrangements. The hammock properties provide numerous advantages when using such a device to form a firepit or grill as described herein.

A method of using a firepit 10 or grill 12 can include pivoting a plurality of legs 20 and a plurality of cross members 22 substantially outwardly such that a frame 14 can be moved from a collapsed position to an extended position. In certain embodiments, the plurality of cross members 22 can be locked into place, such that the plurality of cross members 22 can provide support to the plurality of legs 20 and/or secure the plurality of the legs 20 when the frame 14 is in the extended position. In certain embodiments, a length of one or more of the plurality of legs 20 can be adjusted. A first hammock 16 can be unrolled and releasably coupled to the frame 14 and a fuel load, such as, for example, charcoal or wood, can be loaded onto the first hammock 16. However, in other embodiments, a first hammock can be remain attached to a frame in a collapsed position, such that the first hammock can be configured to receive a fuel load upon moving the frame to an extended position. The fuel load can be ignited once loaded into the first hammock 16. In certain embodiments relating to a grill, a grate 66 can be added and positioned upon two or more of the plurality of cross members 22, and secured thereto. Once in use, the grill can be used to cook a variety of food products on or over the grate. And in certain embodiments, relating to the firepit 10 or grill 12, a spark screen (not shown) can be positioned substantially around the frame 14.

The foregoing description of embodiments and examples has been presented for purposes of illustration and description. It is not intended to be exhaustive or limiting to the forms described. Numerous modifications are possible in light of the above teachings. Some of those modifications have been discussed, and others will be understood by those skilled in the art. The embodiments were chosen and described in order to best illustrate principles of various embodiments as are suited to particular uses contemplated. The scope is, of course, not limited to the examples set forth herein, but can be employed in any number of applications and equivalent devices by those of ordinary skill in the art.

What is claimed is:

1. A firepit comprising:
a frame, including:
an adapter;
a plurality of legs, each of the plurality of legs having a top end and a bottom end, and each leg being pivotally coupled to the adapter, proximate the respective top end, such that each leg is configured to pivot between an extended position and a collapsed position;
a plurality of cross members, each of the plurality of cross members having a first arm pivotally coupled to a second arm, wherein the first arm is pivotally coupled to one of the plurality of legs and the second arm is pivotally coupled to a neighboring leg, such that the first and second arms are configured to pivot with respect to each other as the plurality of legs pivot between the extended position and the collapsed position; and
a first hammock releasably coupled to the frame, such that the first hammock is substantially positioned beneath the adapter and within a space defined by the plurality of legs, wherein the first hammock is configured to be rollable, and wherein the first hammock is capable of withstanding a temperature of about 700° F. or more.

2. The firepit of claim 1, comprising three legs.

3. The firepit of claim 1, comprising four legs.

4. The firepit of claim 1, wherein the first hammock is capable of withstanding a temperature of about 1,500° F. or more.

5. The firepit of claim 1, wherein each of the plurality of legs includes an outer portion and an inner portion, the outer portion being configured to receive the inner portion, such that the inner portion is slidably extendable from and retractable into the outer portion.

6. The firepit of claim 5, wherein the inner portion can be locked at a number of different locations relative to the outer portion, such that the length of each leg can be adjusted.

7. The firepit of claim 1, wherein each of the plurality of legs is coupled to each of its respective neighboring legs by one of a plurality of cross members.

8. The firepit of claim 1, wherein each of the first and second arms includes a first end and a second end, the first and second arms being pivotally coupled to each other at the respective second ends.

9. The firepit of claim 8, wherein the second end of one of the first and second arms includes a hinge attachment, the hinge attachment having a tab that extends over the second end of the other arm and prevents further pivoting between the first and second arms beyond the extended position.

10. The firepit of claim 1, wherein each of the first and second arms includes a first end and a second end, the first arm being pivotally coupled to one of the plurality of legs at its first end and slidably coupled to the another neighboring leg at its second end, and the second arm being pivotally coupled to the neighboring leg at its first end and slidably coupled to the one of the plurality of legs at its second end, such that the first and second arms create an intersection at which the first and second arms are pivotally coupled to each other.

11. The firepit of claim 1, further comprising a second hammock, the first hammock being substantially positioned above the second hammock.

12. The firepit of claim 1, further comprising a spark screen, wherein the spark screen is configured to surround at least a portion of the frame.

13. The firepit of claim 1, wherein the firepit is portable.

14. A grill formed from a firepit of claim 1, wherein a grate is releasably coupled to the frame, such that the grate is substantially positioned over the first hammock.

15. The grill of claim 14, wherein the grate includes a plurality of bars, each of the bars being arranged substantially parallel to each other and connected at each end to a flexible strip, such that the grate is configured to be rollable.

16. The grill of claim 14, wherein each of the plurality of legs includes an outer portion and an inner portion, the outer portion being configured to receive the inner portion, such that the inner portion is slidably extendable from and retractable into the outer portion.

17. The grill of claim 14, wherein the grill is portable.

18. A grill comprising:
a frame, including:
an adapter;
a plurality of legs, each of the plurality of legs having a top end and a bottom end, and each leg being pivotally coupled to the adapter, proximate the respective top end, such that each leg is configured to pivot between an extended position and a collapsed position, wherein each of the plurality of legs includes an outer portion and an inner portion, the outer portion being configured to receive the inner portion, such that the inner portion is slidably extendable from and retractable into the outer portion;
a plurality of cross members, wherein each of the plurality of legs is coupled to each of its respective neighboring legs by one of a plurality of cross members, each of the plurality of cross members having a first arm pivotally coupled to a second arm, the first arm being pivotally coupled to one of the plurality of legs, and the second arm being pivotally coupled to a neighboring leg, such that the first and second arms are configured to pivot with respect to each other as the plurality of legs pivot between the extended position and the collapsed position;
a first hammock releasably coupled to the frame, such that the first hammock is substantially positioned beneath the adapter and within a space defined by the plurality of legs, wherein the first hammock is configured to be rollable, and wherein the first hammock is capable of withstanding a temperature of about 1,000° F. or more; and
a grate releasably coupled to the frame, such that the grate is substantially positioned over first hammock, wherein the grate includes a plurality of bars, each of the bars being arranged substantially parallel to each other and connected at each end to a flexible strip, such that the grate is configured to be rollable.

19. A firepit comprising:
a frame, including a first support structure and a second support structure; and
a hammock configured to releasably attach to the frame between the first support structure and the second support structure, wherein the hammock is configured to be rollable, and wherein the hammock is capable of withstanding a temperature of about 1,000° F. or more.

20. A firepit comprising:
a frame comprising at least one support structure; and
a hammock substantially supported by the at least one support structure, wherein the hammock is configured to be rollable, and wherein the hammock is capable of withstanding a temperature of about 1,000° F. or more.

21. A hammock configured to hold a fuel load, the hammock being rollable and capable of withstanding a temperature of about 1,000° F. or more.
